(19) United States
(12) Patent Application Publication
(10) Pub. No.: US 2003/0112989 A1
(43) Pub. Date: Jun. 19, 2003

(54) Microphone sound directing device

(76) Inventor: Koock Elan Jung, Queensbury, NY (US)

Correspondence Address: ERNEST G CUSICK, 30 MARCEL ROAD, Clifton Park, NY, 12065, US

(21) Appl. No.: 10/017,645

(22) Filed: Dec. 14, 2001

(51) Int. Cl. H04R 25/00

(52) U.S. Cl. 381/316; 381/160

(57) ABSTRACT

The invention sets forth a resonance enhancing device for a microphone. The resonance enhancing device is adapted to direct a user's sound waves to a spherical microphone section of the microphone. The resonance enhancing device comprises a body. The body comprises a first end and a second end. The first end is designed for encircling a portion of the microphone and the second end of the body is designed for defining an opening that is disposed proximate the spherical microphone section of the microphone. Thus, when a user sings into the resonance enhancing device and the sound waves of the user are directed by the resonance enhancing device to the spherical microphone section of the microphone, thereby altering the resonance of the sound waves at the spherical microphone section of the microphone.

### BACKGROUND OF THE INVENTION

The invention relates to an attachment for a microphone. In particular, the invention relates to an attachment for a microphone that can direct sound to a microphone's sound pick-up section.

The present invention is in the field of electronic sound reinforcement, relating more particularly to an improved audio system for reinforcing speech in situations requiring an overall “natural” quality with a high level of fidelity and intelligibility, along with full audience coverage and localization of the source.

### SUMMARY OF THE INVENTION

One aspect of the invention sets forth a resonance enhancing device for a microphone. The resonance enhancing device is adapted to direct a user's sound waves to a spherical microphone section of the microphone. The resonance enhancing device comprises a body. The body comprises a first end and a second end. The first end is designed for encircling a portion of the microphone and the second end of the body is designed for defining an opening that is disposed proximate the spherical microphone section of the microphone. Thus, when a user sings into the resonance enhancing device and the sound waves of the user are directed by the resonance enhancing device to the spherical microphone section of the microphone, thereby altering the resonance of the sound waves at the spherical microphone section of the microphone.

Another aspect of the invention sets forth the resonance enhancing device body being is attached to a cylindrical neck of the microphone.

Another aspect of the invention sets forth the resonance enhancing device wherein the resonance enhancing device is formed with a shape suitable to direct sound waves into the spherical microphone section of the microphone.

A further aspect of the invention sets forth the resonance enhancing device wherein the resonance enhancing device comprises a generally conical funnel shape.

Further, an aspect of the invention sets forth the resonance enhancing device comprising a generally bell-shape.

Another aspect of the invention sets forth the resonance enhancing device in which the first end of the body attaches in contact to the cylindrical neck of the microphone.

A still further aspect of the invention comprises the first end that attaches in a spaced relation with the cylindrical neck of the microphone with spacers attached to the first end.

Another aspect of the invention provides the second end of the resonance enhancing device is disposed proximate the spherical microphone section end of the microphone.

These and other aspects, advantages and salient features of the invention will become apparent from the following detailed description, which, when taken in conjunction with the annexed drawings, where like parts are designated by like reference characters throughout the drawings, disclose embodiments of the invention.

### BRIEF DESCRIPTION OF THE DRAWINGS

FIG. 1 is a perspective illustration of a conventional microphone, as embodied by the invention;

FIG. 2 is a side schematic illustration of the Karaoke microphone apparatus and system, as embodied by the invention;

FIG. 3 is a side schematic illustration of the Karaoke microphone apparatus and system, as embodied by the invention;

FIG. 4 is a side schematic illustration of the Karaoke microphone apparatus and system, as embodied by the invention, with the resonance enhancing device positioned proximate to the spherical microphone section of the microphone;

FIG. 5 is a schematic illustration of a sheet of material that can be used to form a resonance enhancing device for the Karaoke microphone apparatus and system, as embodied by the invention;

FIG. 6 is a side cross-sectional illustration of a double-walled structure for a resonance enhancing device of a Karaoke microphone apparatus and system, as embodied by the invention;

FIG. 7 is an alternative configuration of a resonance enhancing device for a Karaoke microphone apparatus and system, as embodied by the invention;

FIG. 8 is another alternative configuration of a resonance enhancing device for a Karaoke microphone apparatus and system, as embodied by the invention;

FIG. 9 is an alternative configuration of a resonance enhancing device for a Karaoke microphone apparatus and system, as embodied by the invention;

FIG. 10 is an additional alternative configuration of a resonance enhancing device for a Karaoke microphone apparatus and system, as embodied by the invention; and

FIG. 11 is a further alternative configuration of a resonance enhancing device for a Karaoke microphone apparatus and system, as embodied by the invention.

### DETAILED DESCRIPTION OF THE INVENTION

The word “KARAOKE”: is a Japanese word meaning “empty orchestra.” Simply put, Karaoke is you and your guest singing along with your favorite songs. What makes Karaoke unique is that the music has the original vocals deleted. The song lyrics appear on a TV monitor to help keep the singer(s) in sync with the music

The Karaoke microphone apparatus and system 1, as embodied by the invention and illustrated in the Figures, comprise a portable Karaoke microphone, generally indicated as 50, is illustrated. Microphone 50 includes a hand-held housing 51 having spherical microphone section 52 coupled to a cylindrical neck 54. The cylindrical neck 54 includes a first end 54a that can be coupled to power and sound cord 55 that leads to an amplifier (not illustrated).

Alternatively, the Karaoke microphone apparatus and system, as embodied by the invention, can comprise a remote wireless microphone with a battery storage housing section in the cylindrical neck 54. In combination, these elements form a lightweight and compact Karaoke microphone that can be easily held by children and adults alike. The user holds the Karaoke microphone apparatus and system 1 by means of the cylindrical neck 54. Based on this configuration, a user of the Karaoke microphone apparatus and system, as embodied by the invention, is able to hold the Karaoke microphone apparatus and system 1 in one hand to simulate a concert-like environment wherein microphone section 50 is pointed upwards towards the user's head so that it has the appearance of an actual microphone.

In the Karaoke microphone apparatus and system, as embodied by the invention, the microphone can be formed of any appropriate material, such as, but not limited to, a clear, colored, or opaque material so that all the Karaoke microphone apparatus and system 1 to further simulate an actual concert microphone. Moreover, different components of the Karaoke microphone apparatus and system, as embodied by the invention, can be made of a combination of materials, including, but not limited to, chrome plating to have a more complementary effect with the other portion of the microphone.

Referring specifically to FIG. 2, the Karaoke microphone apparatus and system, as embodied by the invention, comprise a resonance enhancing device 100. The resonance enhancing device 100 is attached to the microphone 50 (illustrated in phantom). The resonance enhancing device 100 comprises a body that is attached to the cylindrical neck 54 of the microphone 50. The resonance enhancing device 100 is formed with a shape suitable to direct the user's sound waves and voice, as the user sings, into the spherical microphone section 52 of the microphone 50 to enhance or alter or further direct resonance of the sound waves to the sound receiving portion of a microphone 50, as described hereinafter.

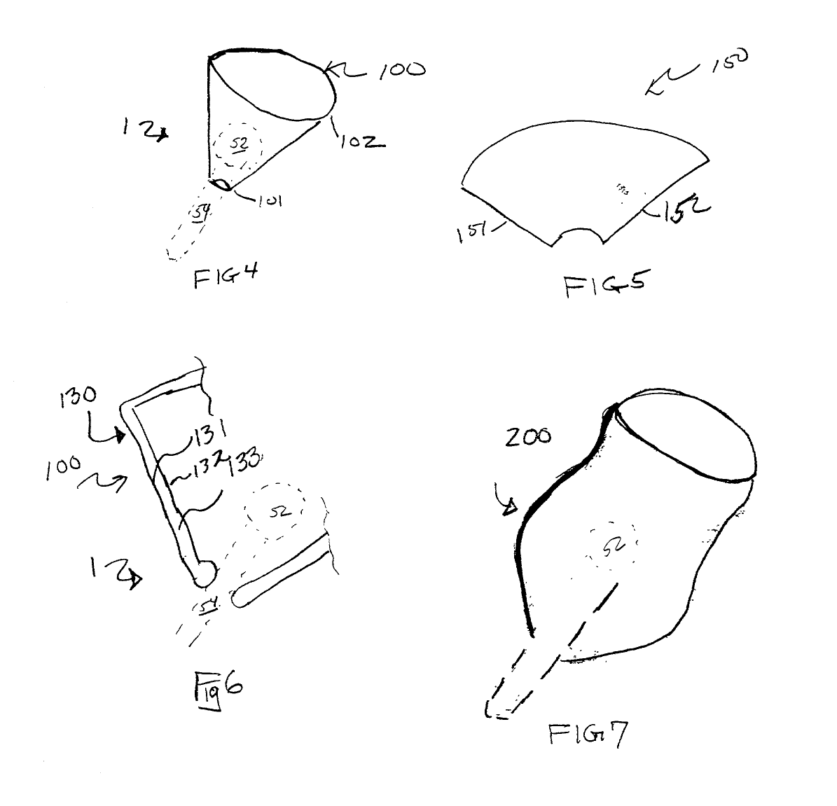

The resonance enhancing device 100, as embodied by the invention, is illustrated in FIG. 2 in the form of a generally conical funnel shape. The resonance enhancing device 100 comprises a first end 101 that attaches in close proximity to the cylindrical neck 54 of the microphone 50. The close proximity may be in contact, as illustrated in FIG. 2, or in a spaced relation with the cylindrical neck 54 of the microphone 50, for example with spacers 107 attached to the first end 101 (FIG. 3).

A second end 102 of the resonance enhancing device 100 is disposed proximate the spherical microphone section 52 end of the microphone 50, as embodied by the invention. The second end 102 comprises a larger opening compared to the first end 101 of the resonance enhancing device 100. The conical shape of the resonance enhancing device 100, as embodied by the invention, acts to funnel and direct the user's voice and sound waves to the spherical microphone section 52 of the microphone 50. Thus, a user of the Karaoke microphone apparatus and system, as embodied by the invention, will have their sound waves directed to the spherical microphone section 52, and thus their voice may sound better or at least give the impression to the user of the Karaoke microphone apparatus and system 1, as embodied by the invention, that it sounds better.

The Karaoke microphone apparatus and system 1 are disposes on the cylindrical neck 54 of the microphone 50 so the second end 102 of the resonance enhancing device 100 is proximate the spherical microphone section 52 of the microphone 50. This configuration, as illustrated in FIG. 2 is merely exemplary of the possible positionings of the resonance enhancing device 100 in the Karaoke microphone apparatus and system 1, as embodied by the invention. For example, but in no way limiting of the invention, the resonance enhancing device 100, as embodied by the invention, can be positioned closer to the resonance enhancing device 100 of the microphone 50 to present more of the cylindrical neck 54 of the microphone 50 to a user. This configuration is illustrated in FIG. 4.

The resonance enhancing device 100, as embodied by the invention, can be formed of any appropriate material. For example, and in no way limiting of the invention, the resonance enhancing device 100 can be formed of paper, plastic, laminated materials, combinations thereof, and other such materials. The materials of the resonance enhancing device 100 should be sufficiently light-weight so a user of the Karaoke microphone apparatus and system 1, as embodied by the invention, has the ability to easily lift and move the microphone 50 for Karaoke purposes.

The resonance enhancing device 100, as embodied by the invention, can be attached to the microphone 50 in any manner to be retained on the cylindrical neck 54. The resonance enhancing device 100 can be formed as a sheet of material 150, as in FIG. 5 and configured around the microphone 50 to form the resonance enhancing device 100, as illustrated in FIG. 2. For example, and in no way limiting of the invention, the sheet of material 150 can be bent around a microphone 50 attaching the ends 151 and 152 (FIG. 5) to form the generally conical resonance enhancing device 100.

The resonance enhancing device 100 for the Karaoke microphone apparatus and system 1, as embodied by the invention, can have the ends 151 and 152 of the sheet of material 150 attached to each other by any appropriate fastening device. For example, and in no way limiting of the invention, the ends 151 and 152 of the sheet of material 150 can be attached to each other in a permanent fashion, for example by tape, glue, staples or other such means, or in a releasable manner. The releasable manner can include, but is not limited to, adhesive such as on POST-IT notes, snaps, hook and loop (Velcro) fasteners, and the like.

The resonance enhancing device 100, as embodied by the invention, can also comprise at least one hole or aperture 125 in a wall of the resonance enhancing device 100, as illustrated in FIG. 2. The at least one hole or aperture 125 can lead to a resonance box (not illustrated) that can be used to further refine the user's voice and sound waves. The at least one hole or aperture 125 can also be used vent the resonance enhancing device 100 and provide access to the user's voice to other Karaoke performers with the user of the resonance enhancing device 100.

The resonance enhancing device 100, as embodied by the invention, can be formed of a double-walled structure 130 with an internal chamber 133 disposed between two walls 131 and 132 of the resonance enhancing device 100, as embodied by the invention. It is believe that this double-walled structure 130 with an internal chamber 133 can further provide a user of the Karaoke microphone apparatus and system 1 with enhanced voice and sound. Alternatively, the internal chamber 133 of the double-walled structure 130 can be filed with a material that assists in reflecting or absorbing the sound waves of a user of the Karaoke microphone apparatus and system 1. Thus, resonance in the Karaoke microphone apparatus and system 1 can be enhanced, as needed for Karaoke purposes.

The resonance enhancing device 100, as embodied by the invention, for the Karaoke microphone apparatus and system 1 has been described with respect to a conical configuration. As discussed above, this conical configuration of the resonance enhancing device 100 is merely exemplary of the shape of the resonance enhancing device, as embodied by the invention. Another exemplary configuration of the resonance enhancing device 100 is illustrated in FIG. 7. In FIG. 7, the resonance enhancing device 200 comprises a “bell-shaped” configuration.

The shape of the resonance enhancing device, as embodied by the invention, can comprise any shape and configuration to envelope a microphone 50. The enveloping of the microphone 50 can be completely enveloping the microphone 50 or partially enveloping the microphone 50. The degree of enveloping in the Karaoke microphone apparatus and system 1, as embodied by the invention, can vary as long as some of a user's voice is reflected to the spherical microphone section 52 to enhance resonance.

The resonance enhancing device 100, as embodied by the invention, can be positioned on the microphone 50 to allow access to an on/off switch and/or volume rheostat 59 on the microphone 50. If the resonance enhancing device 100 is provided on the microphone 50 towards the spherical microphone section 52 access to the on/off switch and/or volume rheostat 59 is presented. If the resonance enhancing device 100 is disposed lower on the cylindrical neck 54 of the microphone 50, the resonance enhancing device 100 can be provided with a cut-out or similar structure to allow a user to have access to the on/off switch and/or volume rheostat 59.

The above description of the resonance enhancing device 100 for a Karaoke microphone apparatus and system 1, as embodied by the invention, has been described with one type of a microphone, that microphone being generally cylindrical with cylindrical neck 54 and spherical microphone section 52. Alternatively, the resonance enhancing device 100 for the Karaoke microphone apparatus and system 1 can be used with any other type of microphone 50 as long as the resonance enhancing device 100 can focus or direct the voice and sound waves of a user to the spherical microphone section of a microphone. For example, and in no way limiting of the invention, the resonance enhancing device can be attached to a “headphone” type of microphone so that the directing feature of the resonance enhancing device 100 for a Karaoke microphone apparatus and system 1, as embodied by the invention. The scope of the invention is intended to use a resonance enhancing device, as embodied by the invention, with any configuration of a microphone 50, regardless of the shape of the microphone.

FIGS. 8-10 illustrate further embodiments of the resonance enhancing device, as embodied by the invention. In these Figures, like elements are illustrated by like characters with respect to previously described Figures. Thus, a description of those elements is omitted for ease of description purposes. In FIG. 8, the resonance enhancing device 210 is attached to the microphone 50 (illustrated in phantom). The resonance enhancing device 200 comprises a body that is attached to the cylindrical neck 54 of the microphone 50. The resonance enhancing device 210 is formed with a shape suitable to direct the user's sound waves and voice, as the user sings, into the spherical microphone section 52 of the microphone 50 to enhance or alter or further direct resonance of the sound waves to the sound receiving portion of a microphone 50, as described hereinafter.

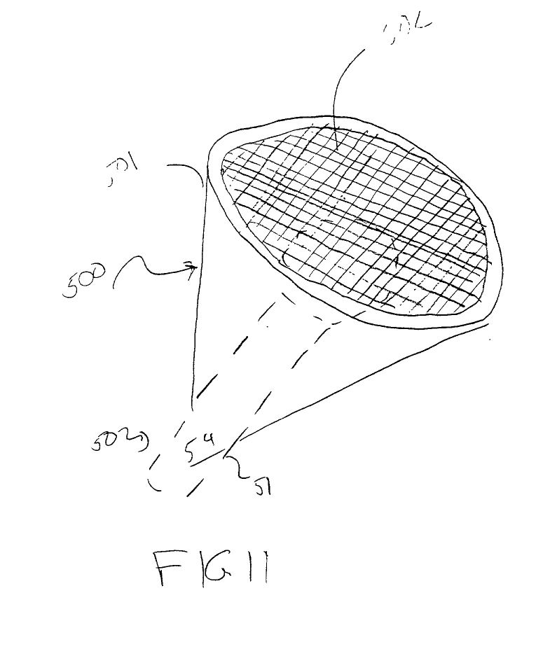

The resonance enhancing device 2100 does not encircle the entire microphone 50 as is illustrated in FIG. 2 and elsewhere, however, the resonance enhancing device 210 of FIG. 8 (and FIGS. 9 and 10 as described hereinafter) extends partially around the microphone 50. The degree of encircluation of the resonance enhancing device 210 can be from extending in an arc x from a few degrees to less than totally encircling, for example a few seconds less than 360 degrees. The extent of encirculation is dependent on the degree of desired direction and reflection of the user's sound waves.

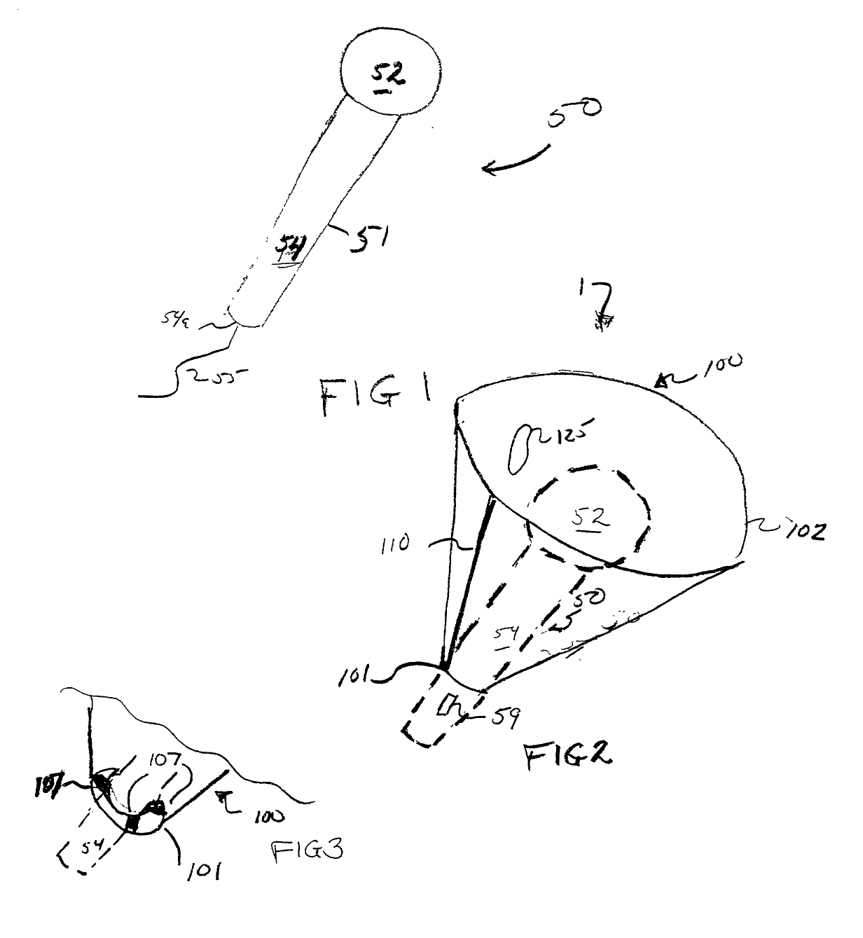

FIGS. 9 and 10 are similar to FIGS. 2 and 1 (inclusive of the at least one hole or aperture 125), with the respective resonance enhancing devices 220 and 230 extending partially around the microphone. Thus, the resonance enhancing devices 220 and 230 merely encircle the microphone 50.

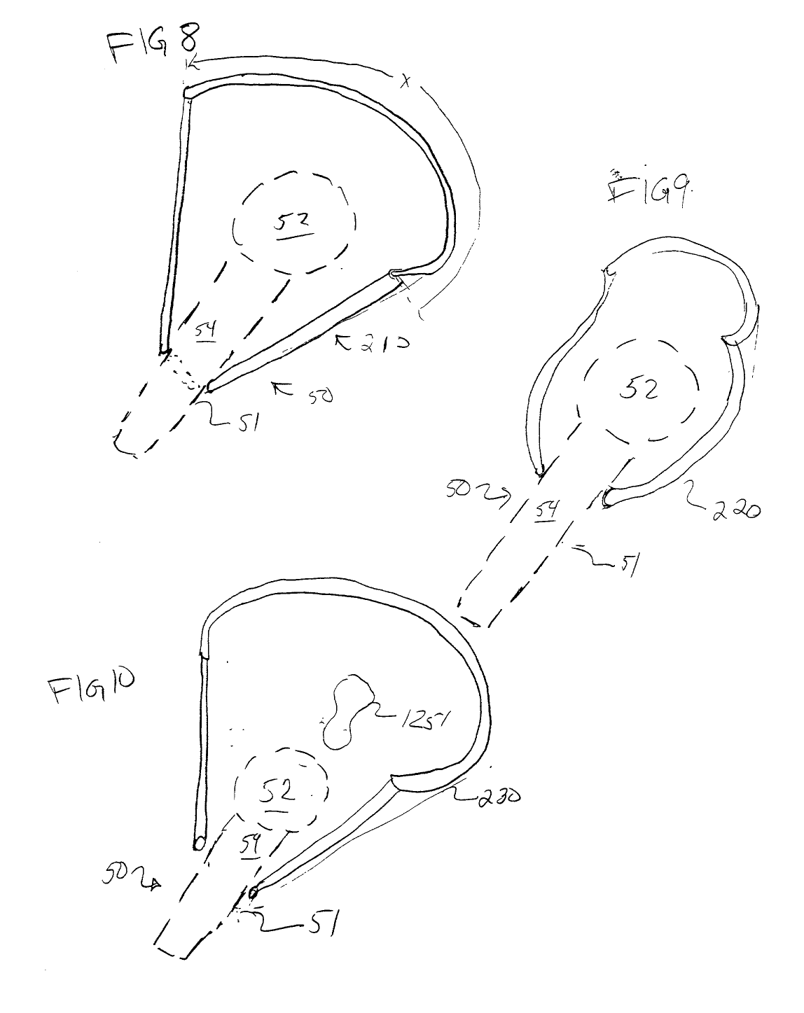

FIG. 11 illustrates a further embodiment of the Karaoke microphone apparatus and system 500, as embodied by the invention. In this Figure, like elements are represented by like reference characters, and a further description of these features will be omitted. Reference to the above description can provide a description of these features. In FIG. 11, the Karaoke microphone apparatus and system 500, comprises a resonance enhancing device 501. The resonance enhancing device 501 is similar to the resonance enhancing devices described above with respect to any one of FIGS. 2-10. Although the resonance enhancing device 501 is illustrated as fully encircling the microphone 50, the resonance enhancing device 501 can partially encircle the microphone, for example as illustrated in FIGS. 8-10.

The resonance enhancing device 501, as embodied by the invention, comprises a screen 502. The screen 502 covers a top opening of the resonance enhancing device 501, for example the fully encircling resonance enhancing device or a partially encircling resonance enhancing device. The screen 502 acts as a filter or screen. It is believed that the screen will act to prevent “whistling” that is often encountered when using a microphone, such as those whistling sounds often caused by feedback. Further, the screen 502 may enhance the resonance, direct, and reflect effects provided by the Karaoke microphone apparatus and system, as embodied by the invention.

The screen 502, as embodied by the invention, comprises any appropriate material. For example, and in no way limiting of the invention, the screen 502 can be formed of a metal, metallic material, cloth, synthetic materials, and combinations thereof. The exact type of material can comprise any such material that does not impact the functionality of the Karaoke microphone apparatus and system.

While embodiments of the invention have been described, the present invention is capable of variation and modification, and therefore should not be limited to the description herein. The invention includes changes and alterations that fall within the purview of the following claims. Individual components of the described and illustrated embodiments may be used interchangeably with each other component of the described and illustrated embodiments.

What is claimed:

1. A resonance enhancing device for a microphone, the resonance enhancing device adapted to direct a user's sound waves to a spherical microphone section of the microphone, the resonance enhancing device comprising:
a body, the body comprising a first end and a second end, the first end encircling a portion of the microphone and the second end of the body defining an opening that is disposed proximate the spherical microphone section of the microphone,
wherein a user sings into the resonance enhancing device and the sound waves of the user are directed by the resonance enhancing device to the spherical microphone section of the microphone, thereby altering the resonance of the sound waves at the spherical microphone section of the microphone.

2. A resonance enhancing device according to claim 1, wherein the body is attached to a cylindrical neck of the microphone.

3. A resonance enhancing device according to claim 1, wherein the resonance enhancing device is formed with a shape suitable to direct sound waves into the spherical microphone section of the microphone.

4. A resonance enhancing device according to claim 3, wherein the resonance enhancing device comprises a generally conical funnel shape.

5. A resonance enhancing device according to claim 3, wherein the resonance enhancing device comprises a generally bell-shape.

6. A resonance enhancing device according to claim 1, wherein the first end attaches in contact to the cylindrical neck of the microphone.

7. A resonance enhancing device according to claim 1, wherein the first end attaches in a spaced relation with the cylindrical neck of the microphone with spacers attached to the first end.

8. A resonance enhancing device according to claim 1, wherein the second end of the resonance enhancing device is disposed proximate the spherical microphone section end of the microphone.

9. A resonance enhancing device according to claim 1, wherein the second end comprises a larger opening compared to the first end of the resonance enhancing device.

10. A resonance enhancing device according to claim 1, wherein the resonance enhancing device can be formed of at least one of paper, plastic, laminated materials, combinations thereof, and other such materials.

11. A resonance enhancing device according to claim 1, wherein the resonance enhancing device comprises a sheet of material with ends that can be bent around a microphone with the ends of the sheet of material being attached to form the resonance enhancing device.

12. A resonance enhancing device according to claim 11, wherein the ends of the sheet of material can be attached to each other by at least one of a permanent fashion and a releasable manner.

13. A resonance enhancing device according to claim 1, wherein the resonance enhancing device comprises at least one hole, the at least one hole can lead to a resonance box and to vent the resonance enhancing device.

14. A resonance enhancing device according to claim 1, wherein the resonance enhancing device comprises a double-walled structure with an internal chamber disposed between two walls of the resonance enhancing device.

15. A resonance enhancing device according to claim 1, wherein the resonance enhancing device can be attached to a “headphone” microphone.

16. A resonance enhancing device according to claim 1, wherein the second end encircles the microphone and is closed on itself.

17. A resonance enhancing device according to claim 1, wherein the second end partially encircles the microphone and is open at ends.

18. A resonance enhancing device according to claim 1, wherein the second end comprise a screen covering at least part of the opening.
